(19) United States
(12) Patent Application Publication
(10) Pub. No.: US 2012/0201038 A1
(43) Pub. Date: Aug. 9, 2012

(54) Luminaire

(75) Inventors: Jan Birnstock, Dresden (DE); Sven Murano, Dresden (DE); Torsten Coym, Dresden (DE); Holger Storck, Dresden (DE); Steffen Goebel, Dresden (DE); Sebastian Wolfram, Dresden (DE); Kai Gilge, Dresden (DE)

(73) Assignee: Novaled AG, Dresden (DE)

(21) Appl. No.: 13/362,240

(22) Filed: Jan. 31, 2012

(30) Foreign Application Priority Data
Feb. 7, 2011 (EP) 11153602.5
Feb. 14, 2011 (DE) 102011000716.4

(51) Int. Cl. F21V 21/00

(52) U.S. Cl. 362/404; 362/382; 362/410

(57) ABSTRACT

The invention relates to a luminaire, in particular a table luminaire, having a luminaire body formed from a fibre-reinforced material and at least one lighting element, which is arranged on the luminaire body in an assigned lighting element holder and embodied as an OLED lighting element.

### CROSS-REFERENCE TO RELATED APPLICATIONS

This application hereby claims priority to European Patent Application No. 11 153 602.5, filed 7 Feb. 2011, and German Patent Application 10 2011 000 716.4, filed 14 Feb. 2011 the disclosures of which are expressly incorporated herein by reference.

### FIELD OF THE INVENTION

The invention relates to a luminaire.

### BACKGROUND OF THE INVENTION

In general, luminaires are used to generate light for illumination purposes, using a lighting means, a lamp or lighting element, and are known in different embodiments. Devices which have also been proposed as lighting means are so-called OLEDs (Organic light-emitting diodes).

From document DE 20 2010 008 324 U1, an organic lighting device is known, having a light source which comprises a fiat luminous surface, formed from one of more organic light-emitting diodes, a connection device that couples to electrodes of the one of more organic light-emitting diodes in order to apply an electrical voltage, and a plug device that is electrically connected to the connection device and is configured for a receptacle that can rotate about a rotational axis in an associated plug receptacle, in such a manner that the flat luminous surface can pivot about the rotational axis when the plug device is plugged in.

Document DE 10 2008 051 012 A1 relates to a light-emitting device having an arrangement of organic light emitting zones formed in two dimensions on a substrate, which are connected to electrodes and are formed such that they are separated from one another by means of passive intermediate zones, wherein on a light emission side a first light decoupling zone assigned to the light emitting organic regions with a first light-scattering capability, and a second light decoupling, zone assigned to the passive intermediate zones with a second light-scattering capability greater than the first light-scattering capability, are formed.

Document DE 10 2008 035 471 A1 relates to a light-emitting device having a two-dimensional arrangement of separately formed lighting elements, wherein organic zones of adjacent lighting elements are each separated from one another by means of an assigned intermediate zone, and a respective light-decoupling element which is arranged on a light-outlet side of the lighting element, and with an electrical series circuit that is formed through the intermediate zone between the lighting element and the lighting element adjacent thereto.

From document US 2004/0119402 A1 a lighting system is known having external optical means for reflecting and focussing the light emitted by the OLED (organic light emitting diode), wherein the external optical means comprise a recess in order to accommodate the OLED.

From document US 2004/042199 A1 a lighting means is known comprising a plug which is cut out of the substrate.

### BRIEF SUMMARY

This object is achieved according to the invention by a luminaire, in particular a table luminaire, having a luminaire body formed from a fibre-reinforced material and at least one lighting element, which is arranged on the luminaire body in an assigned lighting element holder and embodied as an OLED lighting element. Advantageous configurations of the invention are the subject matter of dependent secondary claims. It can be provided that the at least one lighting element is exchangeable in the assigned luminaire holder.

### BRIEF DESCRIPTION OF THE DRAWINGS

The invention is described in greater detail in the following, with the aid of exemplary embodiments and by reference to the Figures of a drawing. They show:

FIG. 1 a perspective view of a luminaire embodied as a table luminaire, having a luminaire body made of fibre-reinforced material,

FIG. 2 an exploded view of the luminaire of FIG. 1,

FIG. 3 a schematic view of a section of the stand of the luminaire body,

FIG. 4 a schematic view of the stand section with a switch element,

FIG. 5 a schematic view of the structure of an arm on the luminaire body in cross section, and

FIG. 6 a schematic view of the stand for the luminaire body from below.

### DETAILED DESCRIPTION

The invention comprises the notion of a luminaire, in particular a table luminaire, having a luminaire body formed from a fibre-reinforced material and at least one lighting element, which is arranged on the luminaire body in an assigned lighting element holder and embodied as an OLED lighting element.

By using the fibre-reinforced material the possibility is created of producing a self-supporting luminaire body with low weight. Self-supporting arms with lighting elements can thus be implemented without requiring additional material reinforcement.

The one or more OLED lighting elements are preferably exchangeably accommodated on the luminaire body. Each of the OLED elements has its own substrate, on which one or more OLEDs are arranged and which is separated from the substrate of another OLED lighting element, optionally arranged adjacently. The exchangeability facilitates in one configuration to provide a luminaire with exchangeable OLED lighting elements, wherein said configuration can comprise OLED lighting elements for replacing a previously used OLED-lighting element which has failed, or alternatively OLED lighting elements that emit light of different colours.

A preferred extension of the invention provides that the at least one lighting element is arranged in a flat section of the luminaire body. The use of a plurality of OLED lighting elements is also possible. In such an embodiment, multiple lighting elements can be integrated jointly into a flat section of the luminaire body. It can be provided that the flat section, whether fitted with one or more lighting elements, has an aspect ratio of at least 1:3, preferably of at least 1:5. In the area of the flat section the luminaire body can be formed with a ratio of width to thickness of at least 5:1, preferably of at least 10:1.

In an advantageous configuration of the invention it can be provided that the fibre-reinforced material contains carbon fibres. The fibres of the fibre-reinforced material, regardless of whether carbon fibres are provided or not, preferably have a length of at least 50 mm. In this case it can be provided that shorter fibres from a mixture of fibres are comprised.

An advantageous embodiment of the invention provides that the fibre-reinforced material is formed with a matrix composed of a duroplastic material. The duroplastic material is preferably a transparent material.

A preferred extension of the invention provides that the luminaire body is formed, at least in some sections, as a hollow body.

An extension of the invention provides that the luminaire body is formed without a heat sink. Without a heat sink means in particular that the luminaire body has no additional heat sinks, either inserted into or attached to it, for dissipating the heat generated by the lighting elements in operation. The dissipation and distribution of operational heat takes place wholly or partly by means of the luminaire body itself.

In an advantageous configuration of the invention, it can he provided that at least one weight element is arranged on the luminaire body. It can be provided that the weight element or elements are not integrated into the luminaire body so as to be visible from outside, for example by inserting one or more weight elements through closable openings in the inside of the luminaire body. In one configuration, at least three weight elements separated from one another are provided, which are distributed within the luminaire body. By means of the weight elements, the stability, or resistance to tilting, for example, is improved.

In an advantageous configuration of the invention, the luminaire body can be a self-supporting luminaire body. The luminaire body is then preferably free of additional reinforcing elements in the fibre-reinforced material.

An extension of the invention can provide an anti-slip element, arranged on the luminaire body in the region of a standing surface. In one configuration the at least one anti-slip element is implemented as an anti-slip mat.

One advantageous embodiment of the invention provides that the luminaire is a table luminaire, a floor luminaire or a ceiling luminaire.

In a further embodiment, it can be provided that a switch element with an integrated programmable microprocessor is arranged on the luminaire body. By means of the switch element the one or more lighting elements can be activated in operation, in particular for switching on and off. The electrical wiring of the luminaire is preferably designed for a low-voltage operation.

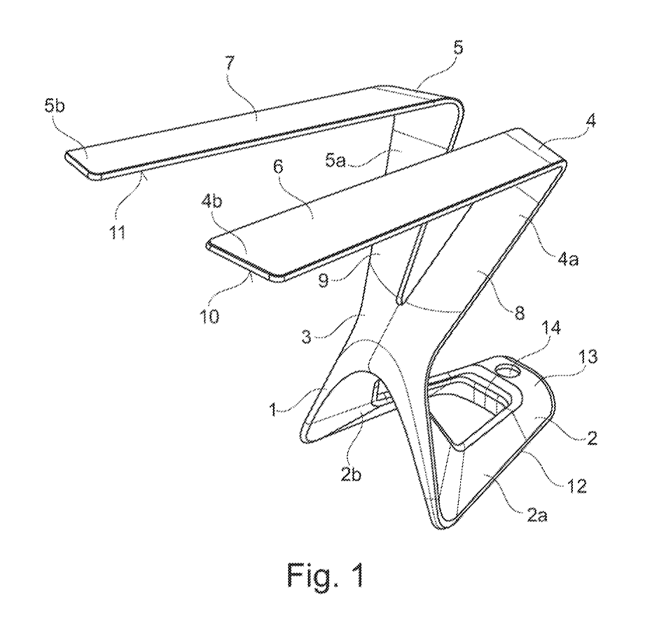

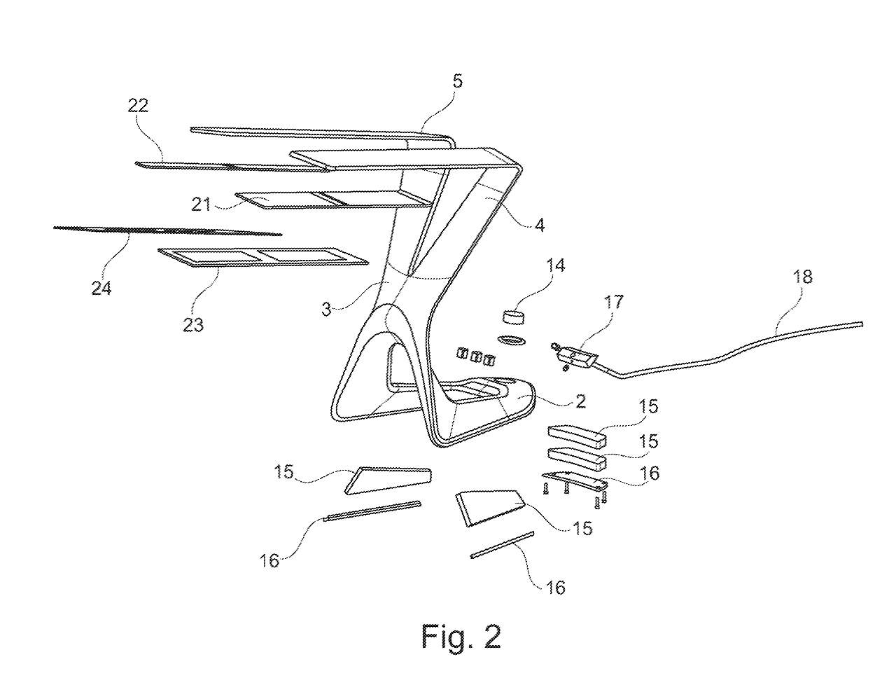

FIGS. 1 and 2 show a perspective view and an exploded view of a luminaire, which is configured as a table luminaire. The following statements are made with reference to the table luminaire in FIGS. 1 and 2. The constructional properties described in this context can also however be partly or wholly applied to other types of luminaire, which include in particular a ceiling luminaire, a wall luminaire, a floor luminaire, a decorative luminaire, an outdoor luminaire and a street luminaire.

A luminaire body 1 comprises a stand 2 which is adjoined by a middle section 3, on which two arms 4, 5 are arranged which can also be referred to as wings. The arms 4, 5 are formed as elongated flat sections. It is preferred that the flat section has an aspect ratio of width to length of at least 1:3, preferably of at least 1:5. The ratio of width to thickness in the region of the flat arms 4, 5, has a value of at least 5:1, preferably at least 10:1.

It can alternatively be provided (not shown), that the luminaire has only one arm. It can also be provided that the luminaire has more than two arms. Two or more elongated arms have the advantage that by this means, the OLED luminous surface can be implemented in a larger size, which is necessary in order to generate sufficient light. Multiple OLEDs which are relatively smaller are preferred over a large-area OLED, because smaller OLEDs mean a greater production yield and are therefore less expensive.

The two arms 4, 5 each have an arm section 4a, 5a, near to the middle section 3, which extends upwards starting from the middle section 3. At an angle thereto, the two arms 4, 5 have distal arm sections 4b, 5b which adjoin the proximal arm sections 4a, 5a. Both the proximal arm sections 4a, 5a and the distal arm sections 4b, 5b are embodied as flat sections. The thickness of the arms 4, 5 in the region of the distal arm sections 4b, 5b is preferably less than approximately 10 mm, more preferably less than approximately 4 mm. An opening angle a between the proximal arm sections 4a, 5a in the embodiment illustrated is approximately 15 degrees. Other opening angles can be provided. In the embodiment illustrated, the luminaire body 1 is mirror-symmetric with respect to a surface extending centrally between the arms 4, 5 from top to bottom.

Covering surfaces 6, 7 are tilted towards each other in the region of the distal arm sections 4b, 5b, so that an external angle between the covering surfaces 6, 7 is greater than 180 degrees. For example, angles between approximately 185 degrees and 200 degrees can be provided.

A bending angle between the proximal arm sections 4a, 5a and the respectively assigned distal arm section 4b, 5b is less than 90 degrees, so that inner surface sections 8, 9 on the proximal arm sections 4a, 5a act as reflectors or reflector surfaces for part of the light emerging on the underside 10, 11 of the distal arm sections 4b, 5b. The reflectors 8, 9 are equipped with a surface that at least partially reflects light, for example by applying a glossy lacquer material. Alternatively or additionally it can be provided that an additional coating is applied in the region of the reflectors 8, 9, for example in the form of a metal coating. By this means, the light reflection in the regions of the reflectors 8, 9 can be individually configured.

In the area of the middle section 3, the two arms 4, 5 are linked together. The middle section 3 then sub-divides again in the lower part in the transition to the stand 2, on which a standing surface 12 is formed.

According to FIGS. 1 and 2, the stand 2 has stand sections 2a, 2b and a transverse section 13 linking the stand sections 2a, 2b together. The stand sections 2a, 2b are linked together with the middle section 3 via upright sections. The standing surface 12 is formed in the region of the two stand sections 2a, 2b and in the region of the transverse section 13. In the embodiment illustrated, the transverse section 13 accommodates a switch element 14 configured as a push-button, with which the luminaire can be switched on and off. The stand sections 2a and 2b are inclined inwards in terms of their surface shape.

From the stand sections 2a, 2b via the middle section 3 to the arms 4, 5, a kind of twisted transition is formed, in which the orientation of the flat sections spatially rotates starting from the stand sections 2a, 2b, via the middle section 3 to the arms 4, 5.

From FIG. 2 it can be seen that weight elements 15 are incorporated into the stand 2, which serve to increase the weight of the stand 2 and consist, for example, of a metallic material. The insertion of the weight elements 15 is effected via openings (cf. FIG. 6, lower drawing) in the region of the standing surface 12 on the stand 2, the openings being fitted with covering elements 16 for inserting or extracting the weight elements 15, which can be fixed in place with the aid of any desired closure techniques, for example a snap-lock and/or a screw-type closure. With regard to their external configuration the weight elements 15 are matched to the internal spaces accommodating them in the stand 2.

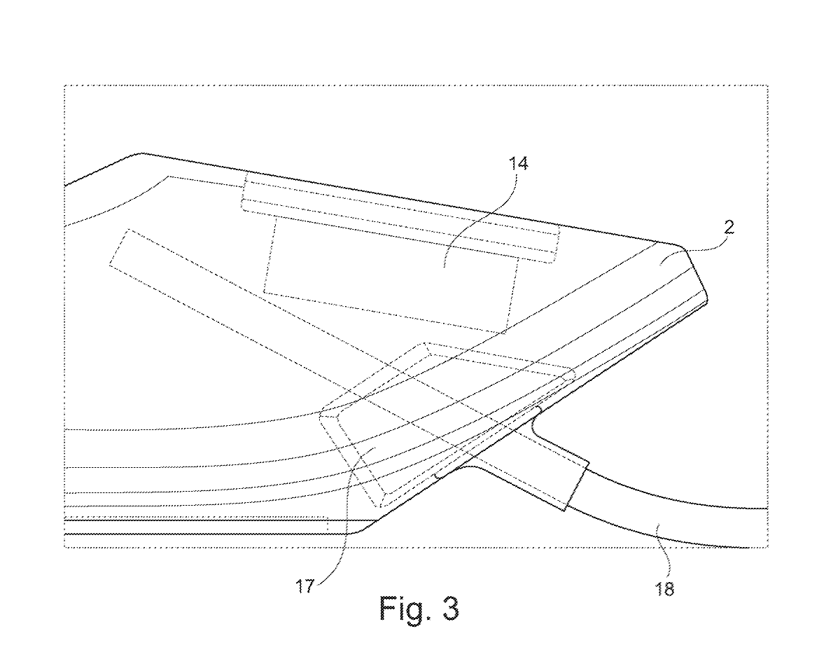

FIG. 3 shows a schematic view of a section of the stand 2 of the luminaire in detail, namely the region with the switch element 14 and a cable conduit 17, via which an electrical supply cable 18 is introduced into the luminaire body 1. By means of the cable conduit 17, mechanical strain relief for the supply cable 18 is also produced. Means can be provided for securing the supply cable 18 in the cable conduit 17 by means of a clamping screw.

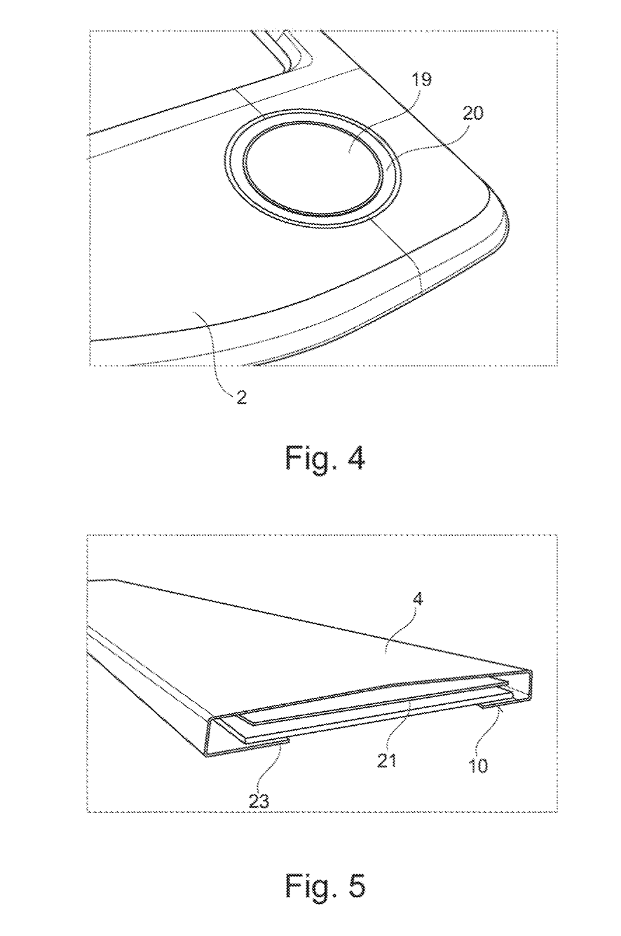

FIG. 4 shows a schematic view of the stand section with the button in detail. The button has an ergonomically adapted contact surface 19 which is enclosed by a ring 20 surrounding the contact surface 19. By means of the switch element 14 a plurality of switch positions can be made available which enable the user to select graduated light levels for the luminaire, in addition to switching it on and off. In particular, a dimmer function can also be provided by means of the switch element 14.

The switch element 14 configured as a push-button can be a capacitive or a mechanical button. It can also be implemented as a piezo-switch. Any desired buttons or switches can be used. It is also possible to integrate a motion sensor into the luminaire body and also, for example, directly into the switch element 14. In one configuration the switch element 14 is formed with an integrated programmable microprocessor or microcontroller. In a further configuration the switch element 14 is a button with a rigidly encapsulated, integrated programmable microprocessor which controls at least the brightness of the luminaire.

By means of the switch element 14, lighting elements 21, 22 are activated (cf. FIG. 2) which are preferably exchangeable and in the embodiment illustrated are in the form of OLED lighting elements (OLED—organic light-emitting diode). The lighting elements 21, 22 are flat lighting means which are arranged in assigned recesses on the underside 10, 11 in the region of the distal arm sections 4b, 5b. In the embodiment illustrated, each of the arms 4, 5 has two OLED lighting elements, which has the advantage that a sufficiently large quantity of light is provided during operation. Also, the use of a plurality of lighting elements in the arms 4, 5 facilitates individual adaptation of the luminaire to different requirements.

In the embodiment illustrated the attachment of the lighting elements 21, 22 takes place by means of support frames 23, 24. In this case it can be provided that the support frames 23, 24 are flush-mounted into assigned frame holders on the underside 10, 11 of the distal arm sections 4b, 5b, so that smooth surfaces are produced. The support frames 23, 24 consist, for example, of a metallic material.

The housing forming the luminaire body 1 is preferably clear of any heat sinks which are additionally mounted in the structure. In one configuration it is provided that the lighting elements 21, 22 are thermally coupled to the luminaire body 1, in order thereby to dissipate waste heat. In this configuration, sections of the luminaire body itself function as heat sinks.

It can be provided that OLED lighting elements are used exclusively, or the OLED lighting elements are supplemented by LED lighting elements. The electrical connection of the lighting elements 21, 22 is preferably effected with a multi-pole cable harness for each of the two arms 4, 5. The lighting elements 21, 22 can be connected to the cable connectors by means of soldered and/or plug-and-socket connections.

If the lighting elements 21, 22 are OLED lighting elements, then the OLEDs used therein can assume any desired configurations in terms of their shape, as are known as such for this type of lighting element. For example, it can be provided that the OLED lighting elements are covered on their light-emitting side with an outcoupling film which optimises the light outcoupling, which enables an optimized light emission of the area.

Depending on the particular embodiment, control elements or control modules, which are matched to the lighting elements 21, 22 used, can be integrated into the luminaire body 1. For example, a printed circuit board assembly with corresponding control elements can be integrated into the stand 2. In conjunction with the control elements it can be provided that these are configured such that one or more of the lighting elements 21, 22 are equipped with a dimmer function. In this way, the user is enabled to carry out individual regulation of the light according to the particular application. The control elements for the lighting elements 21, 22 can be wholly or partially integrated into the lighting elements 21, 22 themselves, so that, for example, a voltage/current conversion necessary for the lighting elements 21, 22 takes place there.

In one configuration a remote control unit is provided, in order to control the control elements integrated into the luminaire bodies. This configuration is preferred in ceiling luminaires, wall luminaires and outdoor luminaires.

In one preferred configuration the luminaire is designed for operation at low voltage, which is equal to or less than 60 V, preferably less than or equal to 24 V and more preferably, less than or equal to 16 V. DC current is preferred. A voltage supply device (power supply) can be provided that converts a higher voltage, for example the standard mains voltage, into a low voltage, which is preferably a DC voltage. The voltage supply device is preferably formed outside of the luminaire body 1 and not integrated therein.

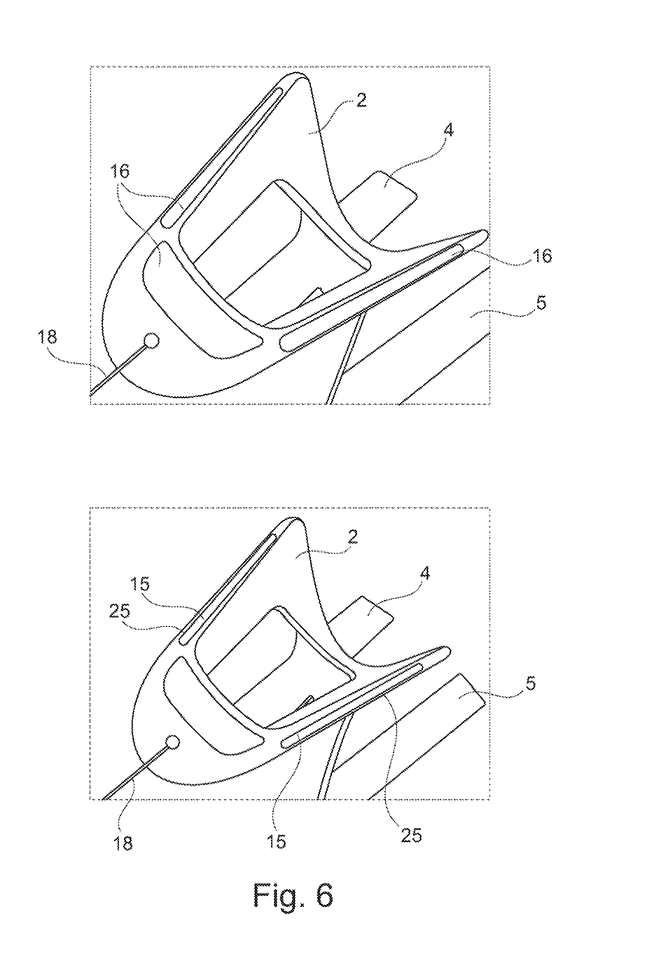

FIG. 5 shows a schematic view of a section of the arms 4, 5 in cross-section. The lighting element 21 shown is fixed to the arm 4 using the support frame 23. In the embodiment illustrated, the lighting element 23 is non-detachably fixed, for example by the support frame 23 being glued in. In other configurations (not shown), the lighting elements 21, 22 can also be detachably fixed to the luminaire body 1, for example with a magnetic connection.

FIG. 6 shows schematic illustrations of the stand 2 of the luminaire body 1 from below. Via openings 25, weight elements 15 are inserted into the stand 2. The openings are then closed off with covering elements 16.

Irrespective of the specifically described embodiments, a preferred configuration of the luminaire is in general one in which the luminaire body, i.e. for example stand 2, middle section 3 and the two arms 4, 5, are implemented integrally or as a single part. Materials that can be used in any desired configuration are fibre-reinforced materials, in particular a material reinforced with carbon fibres. Such materials are processed for example by fibre strands and/or fibre mats being placed into a moulding tool and then cast with a casting compound, optionally using a temperature treatment. Long fibres having a length of several millimetres are preferably used (quasi-infinite fibre length). A luminaire body 1 produced in this way can be subsequently provided with one or more surface layers. Such surface layers can comprise one or more coloured layers. The luminaire body 1 can be provided, at least in some sections, with a metallised surface, for example with a gold layer and/or a silver layer. In one configuration a metallic material can also be deposited onto the fibre, for example by means of electroplating.

In one configuration the luminaire is two-dimensional. In another configuration the luminaire, which is then preferably a table luminaire, has a 3-dimensional (spatial) form.

It is possible to apply a finishing surface layer consisting of clear lacquer. The application of a clear lacquer enables, for example, surface sections of the luminaire body 1 to be obtained with a typical carbon fibre look (carbon look).

In all configurations, it is provided that flat OLEDs are used in the lighting elements. In order to obtain the thinness of the luminaires, no additional optical components such as reflectors or large lenses are used. Integrated and thin outcoupling means can be provided in or on the OLED itself, however. The luminaire is free of optical elements which direct or focus the light.

In one configuration, so-called “bottom emitting” OLEDs are used in the lighting elements 21, 22, which emit through the transparent substrate. In this case it is preferable that a thermal contact is formed between the encapsulation (the semiconductor layers of the OLED lie between the substrate and encapsulation) and the luminaire body 1. If the encapsulation comprises a cavity, this cavity is preferably filled with a heat-conducting substance. The heat-conducting substance is preferably a gas or a liquid with a thermal conductivity of at least 0.1 W/(mK), preferably of at least 1 W/(mK).

In a further configuration, so-called top-emitting OLEDs, which emit through the transparent encapsulation, are used in the lighting elements. In this case it is preferable that a thermal contact is present between the substrate (the semiconductor layers of the OLED lie between the substrate and encapsulation) and luminaire body 1.

The OLEDs used in the lighting elements 21, 22 have a substrate and are encapsulated; electrical contacts are present to provide a power supply. In one embodiment the OLEDs have an integrated circuit which supplies the OLED with a driving current. The circuit is preferably formed on the substrate outside of the encapsulation. Because the OLEDs are used for illumination, they have no so-called backplane and no pixel-based driving.

In the following, a preferred embodiment of a method for producing a luminaire with the luminaire body 1 from fibre-reinforced material is described. In the first step a moulding tool is produced. This can take place by different methods. For example, the required shape can be milled from a block of steel, aluminium or synthetic resin. It is also possible to mill a stock model, and subsequently cut material from this. It is also possible to cut out the shape of the object to be produced directly from an existing or hand-moulded part. The method of shaping which is used can be decided according to the particular application. Factors to be considered here are, for example, the accuracy requirements, temperature resistance, surface quality, the time frame and/or the costs.

Below, the cutter technology used to cut the materials used is described, which in particular also include so-called prepregs. The materials to be used can additionally include carbon fibres, fibreglass, aramide and/or hybrid fibres. Dryer fabrics of various kinds can also be used. The cutter which is used labels the individual cuts by means of inkjet printing, in order to guarantee an exact assignment of the cutter.

This is followed by a laminating step. The pre-impregnated fibres, for example woven and non-woven carbon fabrics (“Prepregs”), are laid in the mould according to the lamination directions produced in the design stage, and then prepared for curing. By means of a layer positioning system, the individual layers are placed in the mould. It is possible to carry out the lay-up work in a clean room, in order to protect the laminates from contamination by, for example, dust or oil. The prepregs can also consist of plastic or metal and be laid manually, covered with perforated foil and non-woven fabric and subsequently vacuum-packed.

Curing takes place in an autoclave under pressure and at high temperature. Curing can be followed by a finishing stage, for example by milling, grinding, polishing, painting or similar.

The fibre reinforcement can be formed by using a mixed fabric, in particular a carbon-fibre based mixed fabric. Materials that can be used are, for example, carbon-metal fibres, carbon-kevlar fibres and/or carbon-glass fibres.

It is preferable to construct the luminaire body 1 free of internal reinforcement elements which form weight-bearing structures. Just such an embodiment can be produced by using the fibre-reinforced materials and a hard resin, for example epoxy resin. A duroplastic matrix is preferred, which for example can also be optically transparent.

The luminaire body is self-supporting. By contrast, in the case of synthetic or plastic housings, such a construction is not possible in the same geometry, because this can lead to elastic deformation, plastic deformation or even breakage.

In the case of the above described production process in particular, it is possible even to integrate cable connectors and/or other elements to be placed in the luminaire body 1 for the electrical operation in the mould during production of the luminaire body 1. Alternatively or in addition, after removal of the luminaire body 1 from the mould, such elements can be arranged in internal cavities of the luminaire body 1.

It is possible to provide the internal cavities in the luminaire body 1 that accommodate electrical elements such as cables or components with an electrically insulating coating, at least in some sections. Also, in one embodiment it can be provided that structural elements of the fibre-reinforced material of the luminaire body 1, for example fibres or woven/non-woven fabric sections which consist of an electrically conducting material, are used as an ground conductor as part of an electrical safety contact. Carbon fibres, for example, are electrically conducting.

It is possible to fix the cables which are accommodated in the internal cavities in the luminaire body 1, in particular the internal cavities can be at least partially filled.

The features of the invention disclosed in the foregoing description, claims and drawings can be of significance both individually and in any desired combination for the implementation of the invention in its various embodiments.

1. A luminaire comprising
a luminaire body, and
at least one lighting element, which is arranged on the luminaire body in an assigned lighting element holder, wherein the luminaire body comprises a fibre-reinforced material and the lighting element comprises an OLED lighting element.

2. The luminaire according to claim 1, wherein the at least one lighting element is arranged in a flat section of the luminaire body.

3. The luminaire according to claim 1, wherein the fibre-reinforced material comprises carbon fibres.

4. The luminaire according to claim 1, wherein the fibre-reinforced material comprises a matrix of a duroplastic material.

5. The luminaire according to claim 1, wherein at least one section of the luminaire body is hollow.

6. The luminaire according to claim 1, wherein the luminaire body lacks a heat sink.

7. The luminaire according to claim 1, wherein at least one weight element is arranged on the luminaire body.

8. The luminaire according to claim 1, wherein the luminaire body is self-supporting.

9. The luminaire according to claim 1, wherein an anti-slip element is arranged on the luminaire body in the region of a standing surface.

10. The luminaire according to claim 1, wherein the luminaire is a table luminaire, a floor luminaire, or a ceiling luminaire.
